(19) United States
(12) Patent Application Publication
(10) Pub. No.: US 2008/0174993 A1
(43) Pub. Date: Jul. 24, 2008

(54) Ribbonlike light illumination apparatus

(75) Inventors: Chi-Tang Hsieh, Danshuei Township (TW); Chang-Ming Chen, Taipei City (TW); Chan-Ching Lin, Taipei City (TW); Yen-Chen Lin, Tucheng City (TW)

Correspondence Address: BIRCH STEWART KOLASCH & BIRCH, PO BOX 747, FALLS CHURCH, VA, 22040-0747, US

(73) Assignee: CHIP HOPE CO., LTD.

(21) Appl. No.: 11/819,282

(22) Filed: Jun. 26, 2007

(30) Foreign Application Priority Data
Nov. 8, 2006 (TW) 095141246

(51) Int. Cl. F21S 4/00

(52) U.S. Cl. 362/217

(57) ABSTRACT

The invention provides a ribbonlike light illumination apparatus, comprising a ribbonlike member, a plurality of heat-dissipating fins, and a plurality of light devices. The ribbonlike member has a first surface and a second surface. The heat-dissipating fins are disposed on the first surface. The light devices are demountably mounted on the second surface. The ribbonlike light illumination apparatus of the invention may be installed in an advertisement box. A more uniform light source than conventional fluorescent lamps can be achieved by adjusting the distances between the light devices on the ribbonlike member. Besides, the ribbonlike light illumination apparatus of the invention has properties of longer life and saves more power than conventional fluorescent lamps.

### BACKGROUND OF THE INVENTION

1. Field of the invention

The present invention relates to a ribbonlike light illumination apparatus, and more particularly, to a ribbonlike light illumination apparatus capable of obtaining a uniform light source by adjusting the distances between light sources.

2. Description of the prior art

An illumination apparatus used in homes, public places, or stores usually uses conventional bulbs, quartz lamps, fluorescent lamps, halogen bulbs, or mercury lamps. These light sources require more space for installation and consume more energy. Besides, a uniform light source is hard to obtain.

In addition, light emitting diode (LED) has the benefits of power saving, high emitting efficiency, and small volume, and it is suitable for illumination in a place with small installation space. However, the heat produced by an LED in operation affects its junction temperature; i.e. it affects the emitting efficiency, the consumed energy, and the life of the LED. The problem of heat dissipation would be especially serious for high power LED.

In terms of its application on advertisement boxes, the light sources traditionally used are usually fluorescent lamps. Fluorescent lamp could form a good uniform light source, but after they are used for a time and before they fail, the emitting area becomes more and more non-uniform. That is, the non-uniform luminance of the advertisement box due to the non-uniform emitting affects the display function of the advertisement box.

Accordingly, the scope of the invention provides a ribbonlike light illumination apparatus with a plurality of light devices. Moreover, the distances between the light devices are adjustable, and the ribbonlike light illumination apparatus provides structural heat dissipating, so as to solve the problems mentioned above.

### SUMMARY OF THE INVENTION

One scope of the invention is to provide a ribbonlike light illumination apparatus.

Another scope of the invention provides a ribbonlike light illumination apparatus capable of obtaining a uniform light source by adjusting the distances between light sources.

According to a preferred embodiment, a ribbonlike light illumination apparatus of the invention includes a ribbonlike member, a plurality of heat-dissipating fins, a plurality of light devices, and a control circuit. The ribbonlike member has a first surface and a second surface. The heat-dissipating fins are disposed on the first surface. The light devices are demountably mounted on the second surface. The control circuit connects the light devices in series with a power cord for controlling the emitting of the light devices.

Moreover, each of the light devices includes at least one LED. Said LED can be white, red, green, blue, yellow, or a combination of different colors. Each of the light devices hereby can emit light of different colors so that the illumination of the ribbonlike light illumination apparatus of the invention carries more varieties. Furthermore, the distances between the light devices mounted on the second surface of the ribbonlike member can be adjusted to obtain a uniform light source. Besides, the LED of each of the light devices is disposed with a lens thereon for uniformly dispersing the light emitted by said LED so that the uniform light source mentioned above is easier to obtain.

In addition, several ribbonlike light illumination apparatuses of the invention can be arranged in parallel and be installed in an advertisement box, and cross-arranging the light devices of the ribbonlike light illumination apparatuses provides a uniform back plane light to replace the conventional light source of fluorescent lamps. The ribbonlike light illumination apparatus of the invention can use LEDs to prolong the life of the light devices. Besides, by use of the lens mentioned above, the plane light provided by the ribbonlike light illumination apparatuses is therefore more uniform.

Similarly, several ribbonlike light illumination apparatuses of the invention can also be connected in series as a mood light, which can be installed on a beam, a staircase, or an embedded ceiling. Besides, the cover of each of the light devices is disposed with a reflector thereon for reflecting a light emitted by said light device to an opposite direction of the reflector. Therefore, the ribbonlike light illumination apparatus can be regarded as a multi-purposeful mood light.

Furthermore, the light devices of the ribbonlike light illumination apparatus of the invention can dissipate heat directly via the ribbonlike member so that the junction temperature of the LED is lowered to maintain good emitting efficiency and prolong the life of the LED.

As discussed above, the ribbonlike light illumination apparatus can obtain a required light distribution by adjusting the distances between the light devices. Besides, the heat produced by each of the light devices in operation can be dissipated out via the heat-dissipating fins disposed on the ribbonlike member to lower the junction temperature, improve the emitting stability, and prolong the life.

The advantage and spirit of the invention may be further understood by the following recitations together with the appended drawings.

### BRIEF DESCRIPTION OF THE APPENDED DRAWINGS

FIG. 1 is a schematic diagram according to a preferred embodiment of the invention.

FIG. 2A is a partial blown-up view of the ribbonlike light illumination apparatus. according to the preferred embodiment.

FIG. 2B is another partial blown-up view of the ribbonlike light illumination apparatus according to the preferred embodiment.

FIG. 3A is a schematic diagram according to an application of the invention.

FIG. 3B is a cross section along X-X line in FIG. 3A.

FIG. 3C is a schematic diagram of the mounting positions of the light devices according to the application.

FIG. 4 is a cross section of the ribbonlike light illumination apparatus of the invention disposed on an embedded ceiling.

### DETAILED DESCRIPTION OF THE INVENTION

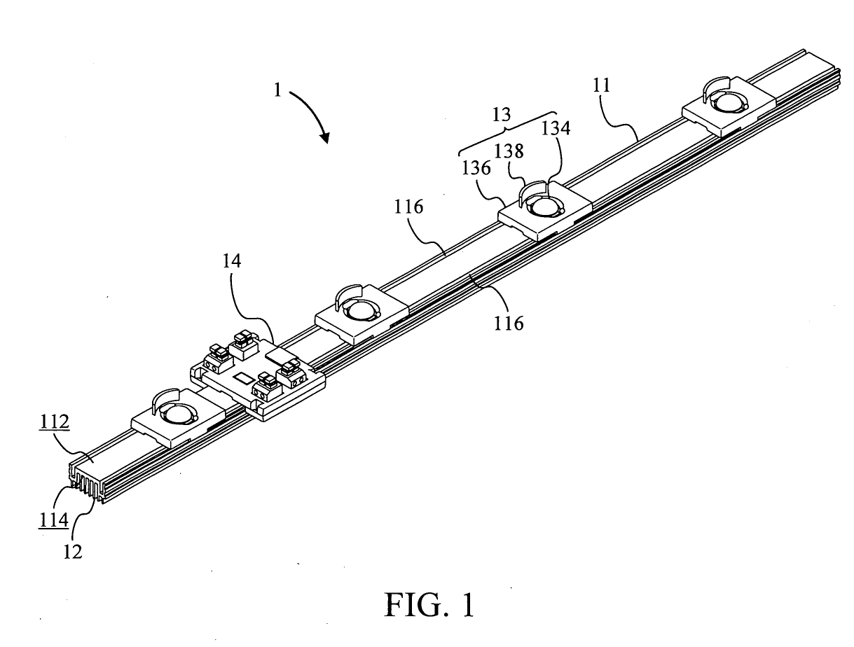

Referring to FIG. 1, FIG. 1 is a schematic diagram according to a preferred embodiment. According to the preferred embodiment, a ribbonlike light illumination apparatus 1 of the invention includes a ribbonlike member 11, a plurality of heat-dissipating fins 12, a plurality of light devices 13, and a control circuit 14. The ribbonlike member 11 has a first surface 112 and a second surface 114. The heat-dissipating fins 12 are disposed on the first surface 112. The light devices 13 are demountably mounted on the second surface 114. The control circuit 14 (not shown in FIG. 1) connects the light devices 13 in series with a power cord for controlling the emitting of the light devices 13. However, in actual applications, the light devices 13 can also be connected in parallel, depending on the product design.

Therein, the first surface 112 is usually opposite to the second surface 114, as shown in FIG. 1, but it is not limited to this. That is, the first surface 112 adjoins the second surface 114 owing to the disposition space limitations or other reasons. Further, FIG. 1 shows the heat-dissipating fins 12 only on one surface. However, heat-dissipating fins can also be disposed on other surfaces of the ribbonlike member 11 in actual applications, depending on the product design. Furthermore, as shown in FIG. 1, the heat-dissipating fins 12 and the ribbonlike member 11 are formed in one piece; it is not limited to this, though. That is, the heat-dissipating fins 12 can be externally attached to the ribbonlike member 11. For example, the heat-dissipating fins 12 are disposed on the ribbonlike member 11 by locking, soldering, sticking, or other ways that mount objects. A one-piece member is usually aluminum extrusion, but it is not limited to this. In principle, the ribbonlike member 11 and the heat-dissipating fins 12 are often made of high thermal-conductive material, but it is not limited to this. In addition, the heat produced by the light devices 13 in operation is mainly dissipated via the heat-dissipating fins 12, so thermal-conductivity problems are noticed when the heat-dissipating fins are externally disposed on the ribbonlike member 11.

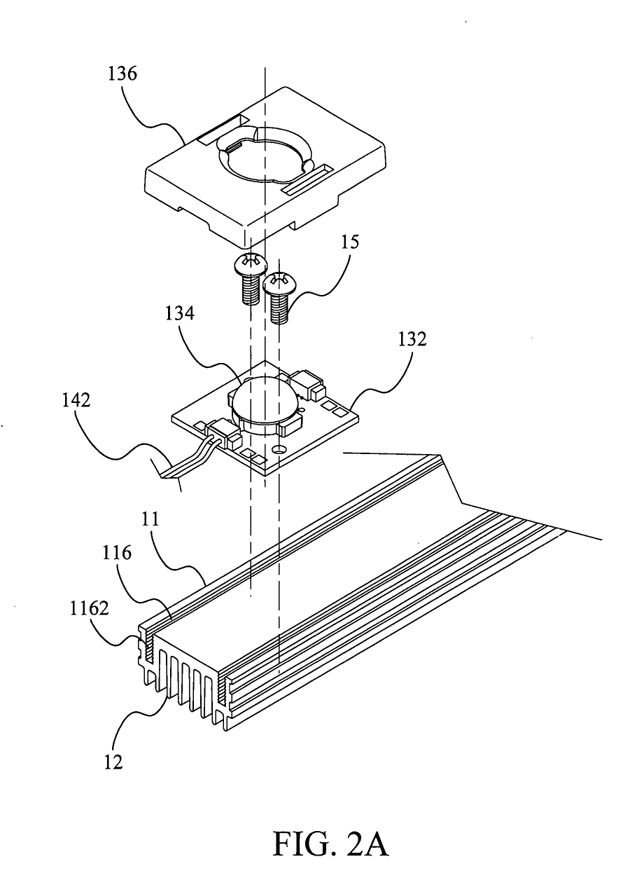

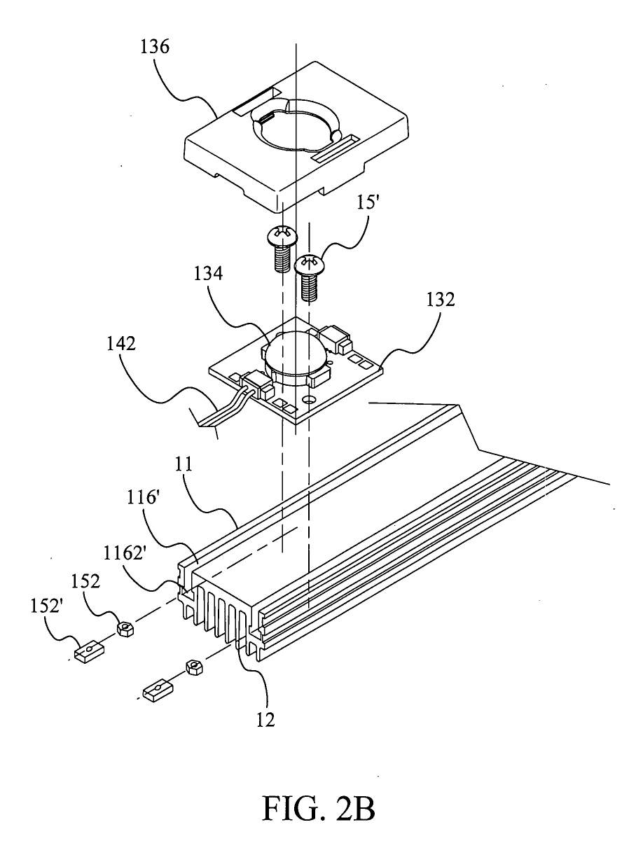

According to the preferred embodiment, each of the light devices 13 includes at least one LED (not shown in FIG. 1), and said LED can be a white LED, a red LED, a green LED, a blue LED, a yellow LED, or a combination LED. Each of the light devices 13 hereby can emit light of different colors, such that the illumination of the ribbonlike light illumination apparatus 1 of the invention can carry more varieties. In addition, the LED of each of the light devices 13 can be soldered on a metal circuit board 132 (not shown in FIG. 1). The metal circuit board 132 directly contacts the second surface 114 of the ribbonlike member 11 for increasing the thermal conductivity (also referring to FIG. 2A and 2B). The LED of each of light devices 13 can also be packaged on a heat-conductive substrate. Each of the light devices 13 is disposed on the second surface 114 such that the heat-conductive substrate tight contacts the ribbonlike member 11 to achieve the heat-conducting effect. Moreover, the LED of each of the light devices 13 is disposed with a lens 134 thereon such that the light emitted by said LED passes through the lens 134 and uniformly disperses out. The ribbonlike light illumination apparatus 1 of the invention hereby can easily produce a uniform ribbonlike light source.

As shown in FIG. 1, each of the light devices 13 further includes a cover 136 for protecting said light device 13. Besides, the cover 136 of each of the light devices 13 is disposed with a reflector 138 thereon. The reflector 138 can reflect the light emitted by said LED to the opposite direction of the reflector 138.

Referring to FIG. 2A, FIG. 2A is a partial blown-up view of the ribbonlike light illumination apparatus 1 according to the preferred embodiment (the reflector 138 is not shown). The ribbonlike member 11 includes a pair of screw slots 116. Each of the screw slots 116 has a transversal thread 1162. Therefore, each of the light devices 13 can be mounted on the second surface 114 of the ribbonlike member 11 by two or more screws 15. The screws 15 are respectively screwed into the screw slots 116. The screws 15 match the transversal thread 1162; that is, the distance of the transversal threads 1162 is substantially equal to the pitch of the screws 15. The depth of the screws 1162 depends on the design requirement. If it is too deep, it would be hard to screw tight, while if it is too low, it would be not screwed smoothly. However, in actual applications, the light devices 13 can also be mounted by self-tapping screws. It is worthy to notice that the light device 13 are mounted by the two screws 15 according to the preferred embodiment, but it could also be mounted by only one screw in actual applications.

Similarly, the ribbonlike member 11 can also include a pair of T-shaped slot 116′, as shown in FIG. 2B. Therefore, each of the light devices 13 can be mounted on the second surface 114 by two or more screws 15′ and matching nuts 152. The nuts 152 are disposed in broader runners 1162′ and are movable only in the runners 1162′. The light devices 13 are mounted on the second surface 114 of the ribbonlike member 11 by making the screws 15′ to engage with the nuts 152, that is, screwing the screws 15′ into the matching nuts 152. It is worthy to notice that the nuts 152 are not limited to standard nuts and can be replaced by a slider 152′ with a threaded hole therein, as shown in FIG. 2B.

Because the light devices 13 are mounted by screws, the mounting of the light devices 13 belongs to demountable mounting so that the mounting positions of the light devices 13 can be arbitrarily changed. The ribbonlike light illumination apparatus 1 of the invention hereby can obtain a required uniform light distribution by adjusting the distances of the light devices 13 mounted on the ribbonlike member 11. Combining the dispersion effect of the lens 134, the ribbonlike light illumination apparatus 1 of the invention can easily obtain a uniform ribbonlike light source. In addition, a power cord 142 for connecting the light devices 13 in series can also be disposed in the screw slots 116 or the T-shaped slots 116′, which not only is beautiful but also protects the power cord 142.

It is worthy to notice that the heat-dissipating fins 12 disposed on the ribbonlike member 11 dissipate heat from the light devices 13 and the light devices 13 had better contact the ribbonlike member 11 as tight as possible. Hence, a high thermal-conductive material, such as silver adhesive, can be filled in the contact interface between the light devices 13 and the ribbonlike member 11 for the improvement of the heat-conducting efficiency.

Therefore, the ribbonlike light illumination apparatus 1 of the invention can obtain the required light distribution by adjusting the disposition distances between the light devices 13. Besides, the heat produced by each of the light devices 13 in operation can be dissipated via the heat-dissipating fins 12 on the ribbonlike member 11 to lower the junction temperature, improve the emitting stability, and prolong the life of the LEDs.

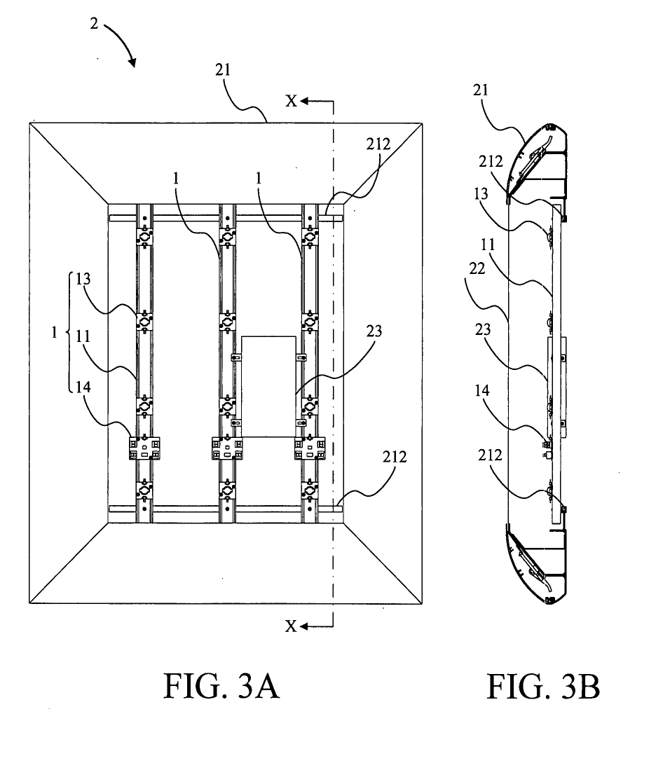

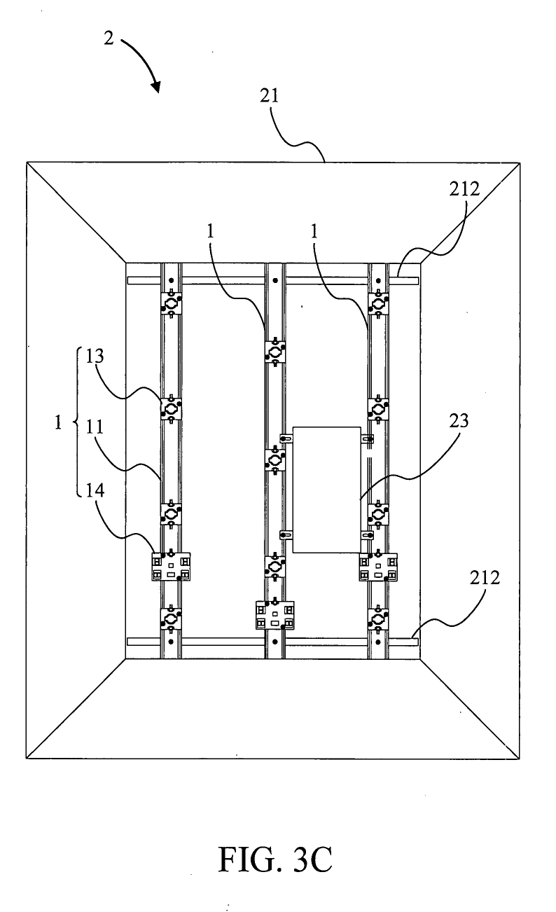

Referring to FIG. 3A and 3B, FIG. 3A is a schematic diagram according to an application. FIG. 3B is a cross section along X-X line in FIG. 3A. According to the application, a plurality of the ribbonlike light illumination apparatuses 1 is installed in an advertisement box 2. The advertisement box 2 includes a casing 21, a screen 22, and a power supply 23. The casing 21 includes a fixture frame 212. The ribbonlike light illumination apparatuses 1 are mounted on the fixture frame 212. According to the application, the power supply 23 is mounted directly on the ribbonlike members 11 of the ribbonlike light illumination apparatuses 1, as shown in FIG. 3A. However, it is not limited to this. The power supply 23 respectively and electrically connects the control circuit 14 of the ribbonlike light illumination apparatuses 1 and supplies power. The emitting direction of the light devices of the ribbonlike light illumination apparatuses 1 is toward the screen 22. The screen 22 carries an advertisement message. The advertisement message is displayed by projecting a uniform plane light produced by the ribbonlike light illumination apparatuses 1 on the screen 22. The mounting positions of the light devices 13 of the ribbonlike light illumination apparatuses 1 are not limited to FIG. 3A, and they can be mounted in interlaced positions, as shown in FIG. 3C. In actual application, the mounting distances of the light devices 13 depend on the requirement of the product to produce the required light distribution.

Therefore, the ribbonlike light illumination apparatus 1 of the invention can replace the conventional fluorescent lamps and has the benefits of power saving, long life, and so on. Especially, the required light distribution can easily be obtained; that is, the light distribution is not limited to uniform plane light.

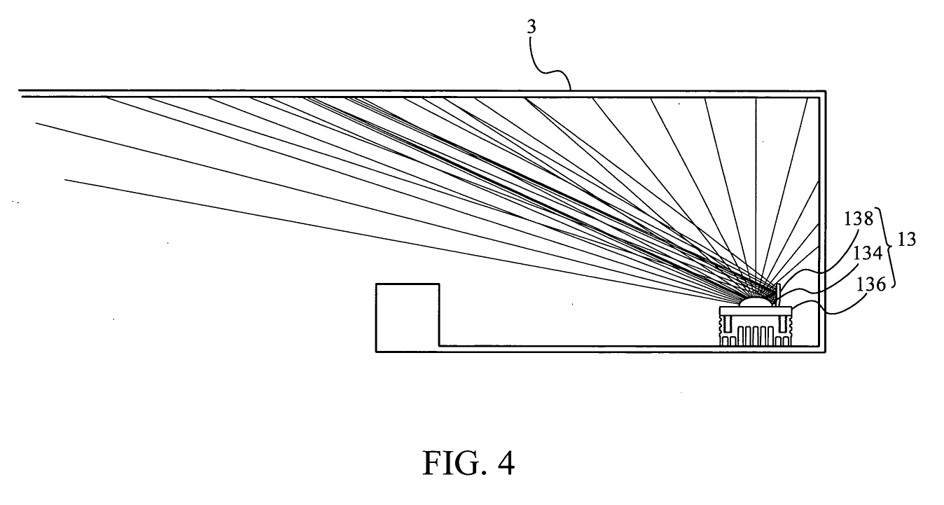

According to another application, a plurality of the ribbonlike light illumination apparatuses 1 of the invention can be connected in series as a mood light, which can be installed on a beam, a staircase, or an embedded ceiling for decorative illumination. In addition, referring to FIG. 4, FIG. 4 is a cross section of the ribbonlike light illumination apparatus 1 of the invention disposed on an embedded ceiling 3. Because each of the light devices 13 of the ribbonlike light illumination apparatus 1 of the invention is disposed with the reflector 138 thereon, the light emitted by said light device 13 is reflected by the reflector 138 so that the propagation of the light is orientated and the decorative illumination can be more multi-purposeful, as shown in FIG. 4.

As described above, the distances between the light devices of the ribbonlike light illumination apparatus of the invention can be adjusted to obtain the required light distribution. Besides, the heat produced by each of the light devices in operation can be dissipated via the heat-dissipating fins of the ribbonlike member to lower the junction temperature, improve the emitting stability, and prolong the life of the LEDs. In addition, because the LEDs chosen can be of different colors, each of the light devices can emit different color lights. Moreover, if the light devices include a plurality of LEDs or combination LEDs, the light devices can selectively emit light of various colors to make the illumination function of the ribbonlike light illumination apparatus wider with more varieties.

With the recitations of the preferred embodiment above, the features and spirits of the invention will be hopefully well described. However, the scope of the invention is not restricted by the preferred embodiment disclosed above. The objective is that all alternative and equivalent arrangements are hopefully covered in the scope of the appended claims of the invention. Accordingly, the above disclosure is construed as limited only by the metes and bounds of the appended claims.

What is claimed is:

1. A ribbonlike light illumination apparatus, comprising:
a ribbonlike member, the ribbonlike member having with a first surface and a second surface;
a plurality of heat-dissipating fins, the heat-dissipating fins being disposed on the first surface; and
a plurality of light devices, the light devices being demountably mounted on the second surface.

2. The ribbonlike light illumination apparatus of claim 1, wherein each of the light devices comprises at least one light emitting diode (LED).

3. The ribbonlike light illumination apparatus of claim 2, wherein the LED of each of the light devices is one selected from the group consisting of a white LED, a red LED, a green LED, a blue LED, a yellow LED, and a combination LED.

4. The ribbonlike light illumination apparatus of claim 2, wherein the LED of each of the light devices is soldered on a metal circuit board, and a lens is disposed above said LED.

5. The ribbonlike light illumination apparatus of claim 1, wherein each of the light devices comprises a cover for protecting said light device.

6. The ribbonlike light illumination apparatus of claim 5, wherein the cover of each of the light devices is disposed with a reflector thereon, and the reflector reflects a light emitted by said light device to an opposite direction of the reflector.

7. The ribbonlike light illumination apparatus of claim 1, wherein the light devices are connected in series by a power cord.

8. The ribbonlike light illumination apparatus of claim 1, wherein the ribbonlike member comprises a screw slot, the screw slot comprises a transversal thread, each of the light devices is mounted on the second surface of the ribbonlike member by a screw, and the screw matches the transversal thread.

9. The ribbonlike light illumination apparatus of claim 1, wherein the ribbonlike member comprises a T-shaped slot, each of the light devices is mounted on the second surface of the ribbonlike member by a screw and a nut, the nut is disposed in the T-shaped slot, and the nut matches the screw.

10. The ribbonlike light illumination apparatus of claim 1, wherein a plurality of the ribbonlike light illumination apparatuses are arranged in parallel and are installed in an advertisement box, so as to provide a uniform back light.

11. The ribbonlike light illumination apparatus of claim 1, wherein a plurality of the ribbonlike light illumination apparatuses are arranged in series and are installed on a beam, a staircase, or an embedded ceiling.
